(19) United States
(12) Patent Application Publication
(10) Pub. No.: US 2013/0090877 A1
(43) Pub. Date: Apr. 11, 2013

(54) LITHOGRAPHY TOOL ALIGNMENT CONTROL SYSTEM

(71) Applicant: Satoshi Nagai, Albany, NY (US)

(72) Inventor: Satoshi Nagai, Albany, NY (US)

(73) Assignee: KABUSHIKI KAISHA TOSHIBA, Tokyo (JP)

(21) Appl. No.: 13/268,248

(22) Filed: Oct. 7, 2011

(51) Int. Cl. G06F 19/00

(52) U.S. Cl. 702/95

(57) ABSTRACT

Described herein are methods and systems for aligning a wafer using a wafer leveling map with alignment marks. A set of alignment marks can be selected to create overlay correction parameters to realign the wafer. Alignment marks that are near wafer leveling hotspots, or alignment marks that have poor reproducibility are not selected for realignment purposes. The wafer leveling data is used to determine which alignment marks have poor reproducibility and can create an unstable offset. The wafer leveling data identifies areas on the wafer that are uneven. Only alignment marks which have a stable offset are used to calculate the associated overlay correction parameters.

### FIELD

Embodiments described herein generally relate to an alignment control system and methods for lithography tool alignment.

### BACKGROUND

Conventional overlay control systems for lithography tools align the wafer or the substrate at the optimum position using an alignment apparatus. During alignment, the positions of the alignment marks printed on the surface of the wafer are read so that a grid, along which a reticle pattern is going to be printed on the wafer, can be calculated. Prior to the execution of alignment process, there is a wafer leveling step, where the surface of the wafer is mapped and is scanned by a scanning apparatus to determine the leveling of the whole wafer. The alignment process works best when there is good reproducibility with regards to wafer leveling. Otherwise the reticle pattern cannot be overlayed to the wafer pattern with enough precision.

Typically, the wafers are chucked to the wafer stage using a vacuum chuck system. However, as next generation lithography technology, such as extreme ultraviolet (EUV) lithography is adopted, vacuum chucking is being replaced with electrostatic chucking methods. It has been recognized however that electrostatic chucking is potentially more likely to cause a non-uniform wafer leveling signature over the whole area of the wafer. This non-uniform layer can result from the wafer itself, such as a warp of the wafer that persists even after the wafer has been chucked to the wafer stage, or also can be induced by an increase in foreign particles between the wafer and the wafer stage. As a result, this non-uniform leveling leads to an increase in the overlay registration error as the non-uniform layer impedes the ability of the alignment apparatus to accurately detect alignment marks on the wafer with which the position of the wafer can be recognized and with which a grid can be correctly determined.

### BRIEF DESCRIPTION OF DRAWINGS

FIG. 1 illustrates a representative schematic of a wafer alignment system in accordance with an embodiment of the subject innovation.

FIG. 2 illustrates a wafer leveling map showing hotspots on a wafer surface in accordance with an embodiment of the subject innovation.

FIG. 3 illustrates a readout of an overlay registration error after having printed a reticle pattern onto a wafer along a grid which is formed on a wafer in accordance with an embodiment of the subject innovation.

FIG. 4 illustrates alignment marks that have been deselected for alignment in accordance with an embodiment of the subject innovation.

FIG. 5 illustrates a flowchart diagram for overlay control in accordance with an embodiment of the subject innovation.

FIG. 6 illustrates a flowchart diagram for checking the reproducibility of alignment mark readout in accordance with an embodiment of the subject innovation.

FIG. 7 is a block diagram illustrating an example computing device that is arranged for at least some of the embodiments of the subject disclosure; and

### DETAILED DESCRIPTION

The subject innovation described herein provides an overlay control system and method wherein the position of the alignment marks on the wafer that are detected by the scanning apparatus are selected based on leveling data. Alignment marks that are near wafer leveling hotspots, or non-uniform areas with regard to the wafer leveling, are ignored, in order that alignment marks meeting reproducibility thresholds are used for alignment. Here the reproducibility is meant for the readout of alignment marks over multiple wafers including those processed on the same lithography tool in the past. Thus, the overlay control system aligns the wafer to a desired location without being misguided by alignment marks that give non-reproducible readout.

If the leveling offset is reproducible, the associated overlay error won't be detrimental to overlay control and mass production because the position of the alignment marks which are recognized by alignment apparatus should be reproducible and thus the overlay error should also be reproducible, which can be compensated by conventional overlay control method, where the overlay correction parameters can be fed forward to next lot processing. On the other hand, in case there are hotspots in the wafer leveling, which is caused by foreign particles between the wafer and wafer stage or a warp of the wafer, the leveling offset is usually non-reproducible or unstable, leading to an overlay error that is non-reproducible and therefore detrimental to overlay control and mass production

The overlay control system can include a wafer chuck that maneuvers a wafer onto a wafer stage, a reticle that overlays the surface of the wafer. The reticle can include circuit pattern arrayed regularly on a grid that matches to a part of a grid pattern printed on the wafer. The grid pattern on the wafer can be determined by reading the position of a set of alignment marks on the wafer surface. The overlay control system can also include a scanning apparatus that performs the wafer leveling and selects a set of the alignment marks that are not associated with hotspots indicated by a non-uniform leveling signature. A processor optionally coupled to memory can determine overlay correction parameters based on the readout of the selected set of the overlay marks and an alignment component can realign the wafer using the overlay correction parameters. Here the overlay mark can be conventional box-in-box mark, with one box having been printed or engraved on the wafer prior to the exposure and the other box now being printed on the wafer by the present exposure step. The mark can be bar-in-bar or whatever type that enables overlay error readout. Or in other embodiment the overlay mark can be the alignment marks both on reticle and the wafer, where the overlay error can be read by projecting the reticle pattern onto the wafer and detect the signal that depends on the offset between those overlapping marks.

In one embodiment, the wafer chuck can maneuver the wafer onto the wafer stage based on a set of coordinates received from a database. In another embodiment, the overlay control system can further include an update component that receives the overlay correction parameters from the processor and creates an updated set of coordinates, which can then be sent to the database. The wafer chuck can then reposition the wafer based on the updated coordinates. In other embodiments, the scanning apparatus selects the set of alignment marks based on the alignment marks being under a reproducibility threshold.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the disclosed information when considered in conjunction with the drawings.

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices can be shown in block diagram form in order to facilitate describing the claimed subject matter.

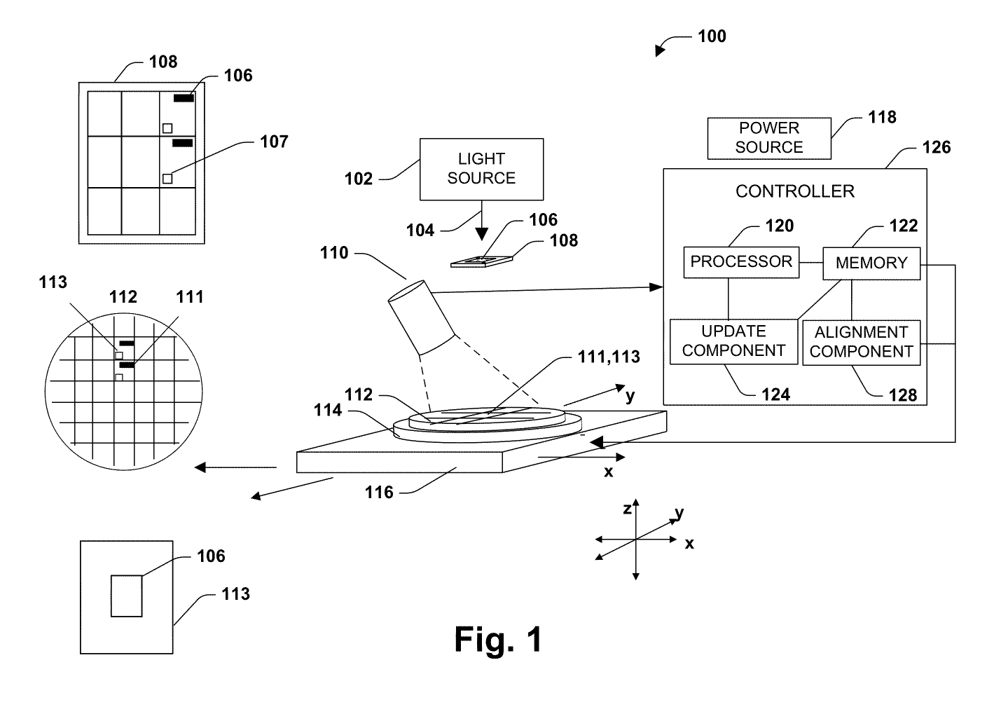

Referring now to FIG. 1, a representative schematic of a wafer alignment system 100 in accordance with an embodiment of the subject innovation is shown. Wafer alignment system 100 includes a reticle 108 with circuit patterns, a set of alignment marks 107, and a set of overlay marks 106. A light source 102 projects light 104 through the reticle 108 so as to project the set of alignment marks 107 or overlay marks 106 onto wafer 112. The overlay error can be measured by reading the relative position of overlay mark 113 on the wafer and overlay mark 106 projected from a reticle 108, or the relative position of alignment mark 111 on the wafer and the alignment mark 107 on the reticle. It is to be appreciated that refractive or reflective systems, catadioptric systems, step-and-repeat or step-and-scan systems and other suitable systems may be employed in carrying out the present invention.

A wafer holder 114 with either vacuum or electrostatic chucking mechanism adsorbs the wafer 112 and is provided for slight rotation relative to a wafer stage 116. The wafer stage 116 is two-dimensionally moveable in an x-direction and a y-direction. The wafer stage 116 and wafer holder 114 are controlled by a controller 126. The controller 126 provides commands that effect rotation of the wafer holder 114 and movement of the wafer stage 116 (via a plurality of motors (not shown)) for wafer alignment and positioning. The controller 126 includes a processor 120 which is programmed to control and operate the various components within system 100 in order to carry out the various functions described herein. The manner in which the processor 120 can be programmed to carry out the functions relating to the present invention will be readily apparent to those having ordinary skill in the art based on the description provided herein.

A memory 122 which is operatively coupled to the processor 120 is also included in the controller 126 and serves to store program code executed by the processor 120 for carrying out operating functions of the system 100 as described herein. The memory 122 includes read-only memory (ROM) and random access memory (RAM). The RAM is the main memory into which the operating system and application programs are loaded. The memory 122 also serves as a storage medium for temporarily storing information such as reticle position, wafer position, reticle coordinate tables, wafer coordinate tables, alignment mark information, programs for determining virtual alignment mark locations and other data which may be employed in carrying out the present invention. For mass data storage, the memory 122 can also include a hard disk drive.

A power supply 118 can provide operating power to system 100. Any suitable power supply (e.g. battery, line power) may be employed to carry out the present invention.

System 100 can also include scanning apparatus 110. Scanning apparatus 110 can be arranged as shown in FIG. 1 where it is at an oblique angle to the optical axis formed by light source 102. Scanning apparatus 110 can also be offset and arranged at an angle parallel to the optical axis. Scanning apparatus 110 can include photo-elements (not shown) that receive scattered and diffused light from the alignment marks printed on the wafer surface. The scanning apparatus 110 can include systems for synchronizing and rectifying the photoelectric signal output by the photo-elements at the vibration period of the light spots and output an alignment signal corresponding to alignment mark deviation from the ideal grid of alignment marks along which circuit patterns on a reticle 108 will be projected on the wafer surface.

Scanning apparatus can also include systems for performing wafer leveling. Wafer leveling is performed to determine the relative height of different portions of the wafer 112. A map depicting the topography of the wafer 112 can then be used together with the alignment signal showing alignment mark deviation from the grid of alignment marks 106. Depending on the topography of the wafer 112, an alignment signal showing a deviation may not in fact be a deviation if there is a local topographical gradient or abnormality under the alignment mark.

Wafer leveling can include optical systems that use beams of light (at wavelengths that will not react with the photo-resist layer on the wafer surface) that bounce off the surface of the wafer 112, and the reflected light is analyzed to determine the topography of the wafer 112. Wafer leveling can also be used to determine a level of tilt of the wafer 112 in one or more of the x-direction and y-direction. The level of tilt can then be corrected by the wafer stage. The manner in which the scanning apparatus performs wafer leveling to carry out the functions relating to the present invention will be readily apparent to those having ordinary skill in the art based on the description provided herein.

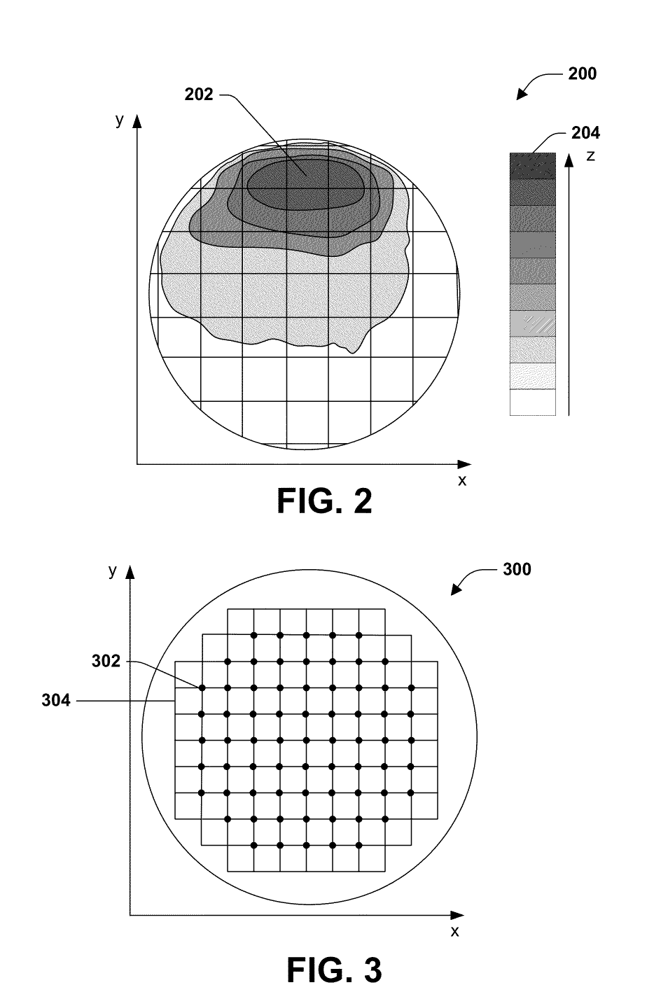

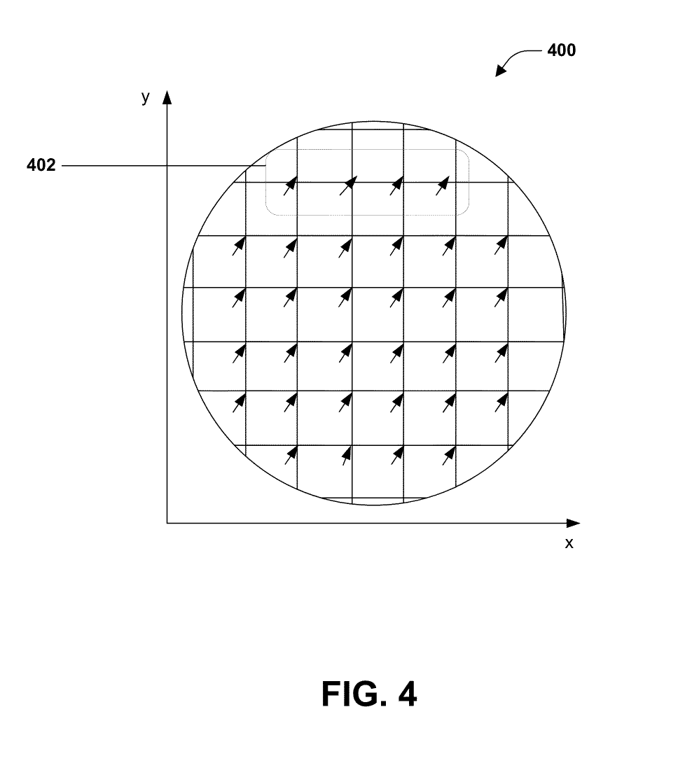

The topography map of the wafer 112 (described further in FIG. 2) created by the wafer leveling can show hotspots or areas of wafer 112 that are elevated. These local elevations are areas where the grid of alignment marks 107 or overlay marks 106 that had been projected on the surface of the wafer 112 may be distorted, and so should be discounted when aligning the wafer 112. The scanning apparatus 110 can compare the wafer leveling results with the alignment marks and the grid to determine which alignment marks correspond to hotspots on the wafer 112 (described in FIG. 4). Once compared, scanning apparatus 110 can select a set of the alignment marks that are not associated with the hotspots.

Controller 126 can receive information about the set of alignment marks. Such information can include which alignment marks have been selected, the location of the alignment marks, and the deviation of the alignment marks from the ideal grid along which circuit patterns on reticle 108 is going to be projected on the wafer 112. Processor 120 can analyze the set of alignment marks to determine overlay correction parameters. Overlay correction parameters can define the offset of the wafer 112 in relation to the optimum placement of the wafer 112. Overlay correction parameters can also include information about how the wafer 112 should be moved in order to reposition the wafer 112 within predefined tolerances.

Overlay correction parameters can include information about not just translational x-direction and y-direction offset, but also rotational offset around the z-axis, as well as tilt induced offset using information from the wafer leveling topography map. Translational and rotational offset can be determined based on the readout of overlay marks 106 and 113 that is printed on the surface of the wafer 112, or the readout of alignment marks 107 and 111.

The overlay correction parameters once calculated by the processor 120, can be sent to the memory 122 for storage. Alignment component 128 can retrieve the overlay correction parameters and can be configured to realign the wafer 112. Alignment component 128 can send instructions to the wafer chuck to maneuver the wafer 112 and wafer holder 114 to the correct position.

The overlay correction parameters can also be retrieved by update component 124. Update component 124 can generate a new set of updated coordinates that can be stored in memory' 122. The updated coordinates can replace the coordinates stored in the wafer coordinate table, or can be stored alongside the original coordinates. In one embodiment, the updated coordinates can be used to maneuver other wafers onto the wafer stage 116 for better alignment. In another embodiment, the wafer chuck can reposition the wafer 112 using the updated set of coordinates. Once the wafer chuck has repositioned wafer 112 using the updated set of coordinates, scanning apparatus 110 can perform wafer leveling again and the overlay can be checked by alignment marks 111 and 107, or after having the overlay marks 106 printed on the wafer the overlay can be checked. If there is an offset, a new set of overlay correction parameters can be determined and the process repeated. This process can be repeated until the wafer is aligned correctly.

Turning now to FIG. 2, a wafer leveling map showing hotspots on a wafer surface in accordance with an embodiment of the subject innovation is shown. Wafer leveling map 200 depicts a representational topographical map of a wafer surface. Different shades marked by the legend 204 correspond to relative heights of the wafer. A hotspot 202 is shown on the map 200. The relative elevation difference is measured in microns (μm). An average height of the wafer, either mean or median, can be assigned as the baseline elevation of 0 μm that the rest of the wafer surface is measured against.

Using the topographical map enables the discovery and determination of the location of hotspots. Hotspots can correspond to areas that are abnormally elevated, suggesting the presence of a foreign particle between the wafer and the wafer stage. In other embodiments, hotspots can correspond to depressions, or negative elevation with respect to the baseline elevation. Depressions can affect alignment in similar ways that bulges affect alignment, by distorting the projected grid, making it impossible to line up the gridlines with the overlay marks on the wafer surface.

The wafer leveling map can be generated by the scanning apparatus. The scanning apparatus can use collimated light beams or lasers to generate the topographical map. Preferentially, the wavelength of light used is one that is non-reactive with the photo-resist layer on the wafer surface. The light beams from the scanning apparatus can reflect off the surface of the wafer and analyzing the resulting backscattering light can measure the relative height of the wafer surface.

The hotspot 202 shown in FIG. 2 corresponds to a relative elevation of 0.25 μm above the baseline. It is to be appreciated that hotspot 202 is not limited to relative elevations over 0.25 μm, and in fact can be anywhere from 0.05 μm to 0.5 μm above or below the baseline elevation. The cutoff point at which an elevation or depression is considered a hotspot will be dependent on the application. In some embodiments, lithography applications may need to be performed within tight tolerances, and so a 0.05 μm cutoff above and below the baseline elevation may be used. In other embodiments, a higher cutoff may be beneficial in order to improve efficiency and decrease time spent aligning the wafer.

Turning now to FIG. 3, a drawing of readout of overlay marks after having printed patterns on reticle 108 onto the wafer 112 along a grid in accordance with an embodiment of the subject innovation is shown. Map 300 represents what the scanning apparatus views when scanning the surface of the wafer. Gridlines 304 represent the grid on the wafer, along which patterns on reticle 108 were to be printed by exposure light from a light source. The arrows at gridline 304 intersections correspond to overlay mark readout, which stands for the offset of the printed patterns with regard to the gridlines 304.

Overlay marks 302 can be printed onto the wafer surfaces, and their placement denotes the proper position of the wafer relative to the gridlines 304. Overlay marks 302 can be numbered, or can be identified using a coordinate system. The coordinates corresponding to the numbered overlay marks can be stored in a database. The gridline intersections can also be numbered or identified using a parallel coordinate system. The database can also store information relating to the intersections and which overlay marks correspond to which intersection.

FIG. 4 illustrates alignment marks that have been deselected for alignment in accordance with an embodiment of the subject innovation. Image 400 is the result of comparing the wafer leveling map shown in FIG. 2 with the overlay mark and gridline scan shown in FIG. 3. Alignment marks 402 are in a location that corresponds to hotspot 202. As the elevation at hotspot 202 was above an application specific cutoff threshold, the alignment marks on the surface of the wafer at that location will not be considered for the grid calculation, as the distortion caused by the hotspot 202 can cause the associated overlay correction parameters to be inaccurate.

In an embodiment, the level of distortion can be measured by the scanning apparatus. The scanning apparatus can compare the wafer leveling map, with the gridlines and accompanying alignment marks. By analyzing the map and images, the scanning apparatus can assign a level of reproducibility to each of the alignment marks. Alignment marks that do not meet a reproducibility threshold can be excluded from consideration, as they would cause increased distortion. Reproducibility can be determined based on distortion of the gridlines (measuring how parallel the gridlines are) or based on the level of focus of the gridlines and alignment marks. Gridlines that are not parallel can indicate that the wafer surface is sloped. Gridlines out of focus can indicate the wafer surface is above or below the baseline elevation.

While reproducibility of the alignment marks and the relative elevation of the alignment marks generally correlate, the relationship is not causal. It is possible for alignment marks that are located in a hotspot to have good reproducibility. If the hotspot is level in the vicinity of an alignment mark, the alignment mark can have a high reproducibility whereas alignment marks located on a gradient can have poor reproducibility.

The scanning apparatus can exclude alignment marks 402 from the set of alignment marks that will be used to determine overlay correction parameters based on either reproducibility of each alignment mark, or whether the alignment mark corresponds to a hotspot. A user can select which method is preferable based on the application.

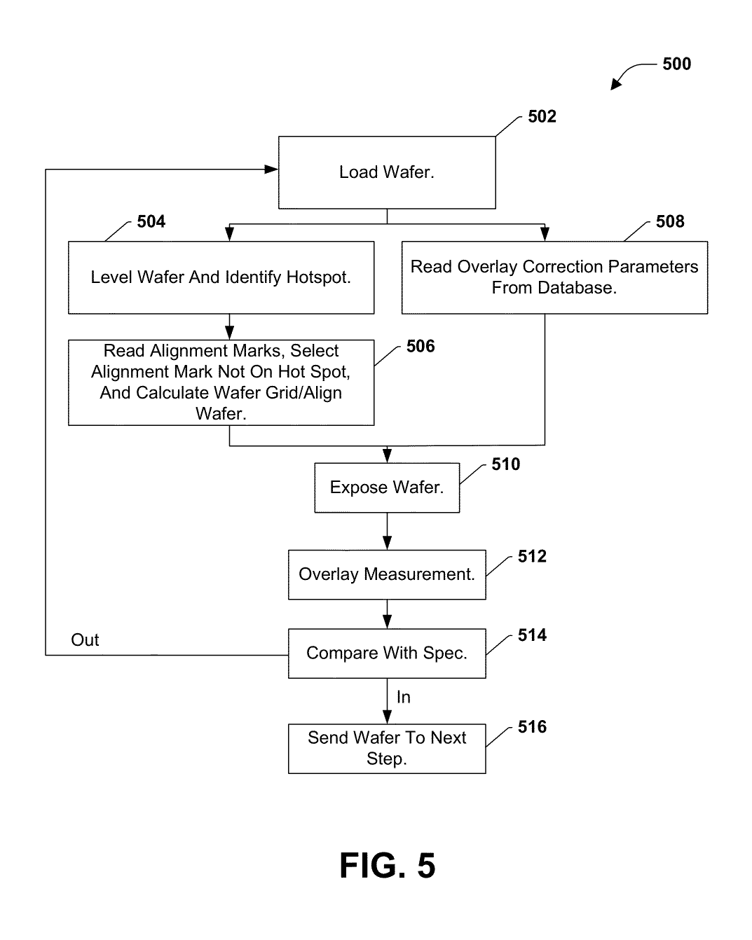

Turning now to FIG. 5, a flowchart diagram for overlay control in accordance with an embodiment of the subject innovation is shown. Method 500 shows the steps involved in aligning a wafer using the techniques described herein. At step 502, a wafer is loaded onto the wafer stage. The wafer can be loaded using an electrostatic chuck or a vacuum chuck. The wafer chuck positions the wafer using a set of coordinates stored in a database. The coordinates can specify the position and orientation of the wafer on the wafer stage.

At 504, the wafer is leveled and hot spots are identified. The wafer leveling can be done by a scanning apparatus that creates a topographical map of the surface of the wafer. Peaks and depressions on the wafer surface, relative to an average elevation or baseline elevation of the wafer can be located. If the peaks or depressions fall within a range between 0.05 μm to 0.5 μm above or below the baseline elevation of the wafer, that region can be identified as a hotspot. The exact threshold can change from application to application, depending on the accuracy needs of each lithography application.

At 506, alignment marks are read off the surface of the wafer by the scanning apparatus. The alignment marks can be etched into or printed on to the wafer surface. Gridlines are projected over the wafer from a reticle placed above the wafer. The intersections of the projected gridlines correspond to the location of the overlay marks on the wafer. The image of the alignment marks read by the scanning apparatus can be compared to the wafer leveling map and alignment marks that are located on top of, or within the vicinity of the hotspots can be identified.

Once those alignment marks have been identified, the other alignment marks can be used to calculate associated overlay correction parameters. The overlay correction parameters can include information about how the wafer should be moved, translation movement and rotational movement, to print the patterns on reticle 108 in a way properly aligned with the grid on the wafer. With the overlay correction parameters, the wafer chuck can reposition the wafer to the correct position.

At 508, if overlay correction parameters have already been created, the wafer can be realigned using the overlay correction parameters stored in a database. These new overlay correction parameters can supplement or override the overlay correction parameters just calculated.

At 510, after the wafer has been repositioned, the wafer can be exposed. When the wafer is exposed, an overlay representing the desired exposure placement can be placed over the wafer at 512. The scanning apparatus can compare the overlay measurement with the exposure results at 514, and determine if correction is needed. If correction is needed, and the overlay measurement does not match the specification, the wafer can be reworked or a new wafer can be loaded and the process repeated in order to obtain more accurate overlay correction parameters. If the overlay measurement does match the specification, the wafer can be sent to the next step at 516.

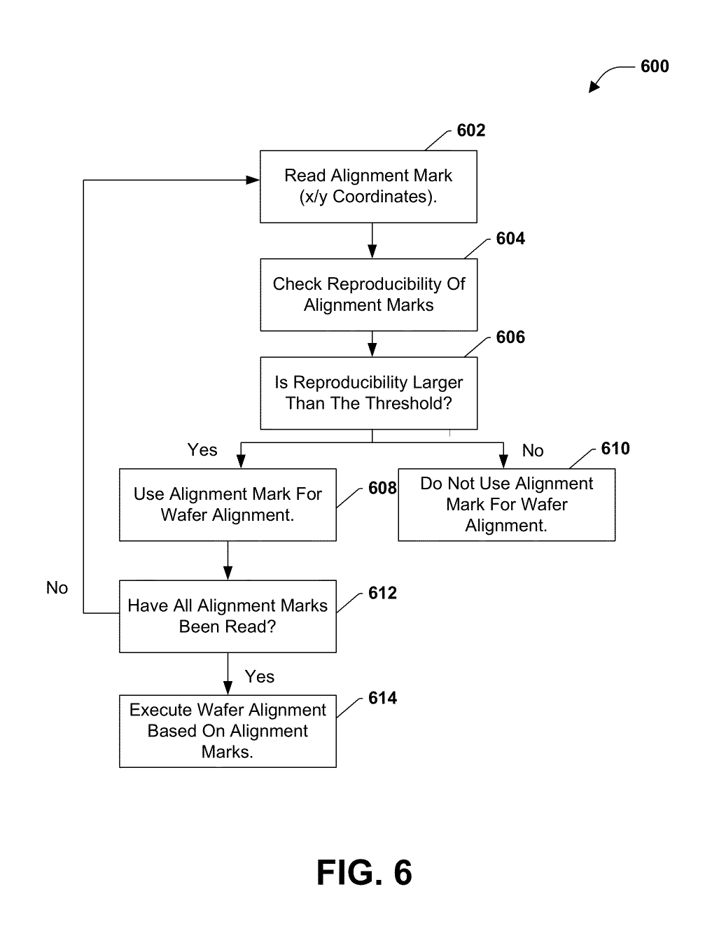

Turning now to FIG. 6, a flowchart diagram 600 for checking the reproducibility of alignment marks in accordance with an embodiment of the subject innovation is shown. At 602, alignment marks are read off the surface of wafer by a scanning apparatus. The scanning apparatus can read the x and y coordinates of the alignment marks so that a grid with which patterns on reticle 108 can be printed onto the wafer can be determined.

At 604, the reproducibility of the alignment marks is checked. To do this, the alignment marks and their locations are compared to a wafer leveling map. The wafer leveling map can show the topography and relative elevations of the wafer surface. Alignment marks that lie in depressions or peaks such as hotspots may have poor reproducibility. As discussed above with regard to FIG. 4, it is possible for alignment marks that are located in a hotspot to have good reproducibility. If the hotspot is level in the vicinity of an alignment mark, the alignment mark can have a high reproducibility whereas alignment marks located on a gradient can have poor reproducibility.

Reproducibility can be determined based on distortion of the gridlines (measuring how parallel the gridlines are) or based on the level of focus of the gridlines and alignment marks. Gridlines that are not parallel can indicate that the wafer surface is sloped. Gridlines out of focus can indicate the wafer surface is above or below the baseline elevation.

At 606, it is determined whether or not the reproducibility exceeds a threshold level. Alignment marks that do not meet a reproducibility threshold can be excluded from consideration, as they would cause increased distortion, and if used to calculate overlay correction parameters would introduce inaccuracies into the calculations. The reproducibility threshold can vary depending on the desired accuracy. Reproducibility threshold can be measured in microns, and is representative of the relative accuracy of the alignment mark. It is desirable for the threshold level to be from 0.003 μm and 0.004 μm. The relationship of the reproducibility to the overlay correction parameters is that an overlay correction parameter calculated with an alignment mark with a reproducibility of 0.003 μm, would be accurate to within ±0.003 μm of the target.

At 608, if the reproducibility of the chosen alignment mark is above the threshold, the alignment mark can be used for wafer alignment, and added to the set of alignment marks that the overlay correction parameters will be calculated from. At 612, if the alignment marks have all been read, the wafer alignment is executed at 614 based on the overlay correction parameters calculated from the set of alignment marks. If the alignment marks have not been all read, the process repeats itself until all alignment marks have been read.

At 610, if the reproducibility of the alignment marks does not meet the threshold, the alignment mark is not placed into the set of the alignment marks to be used for alignment.

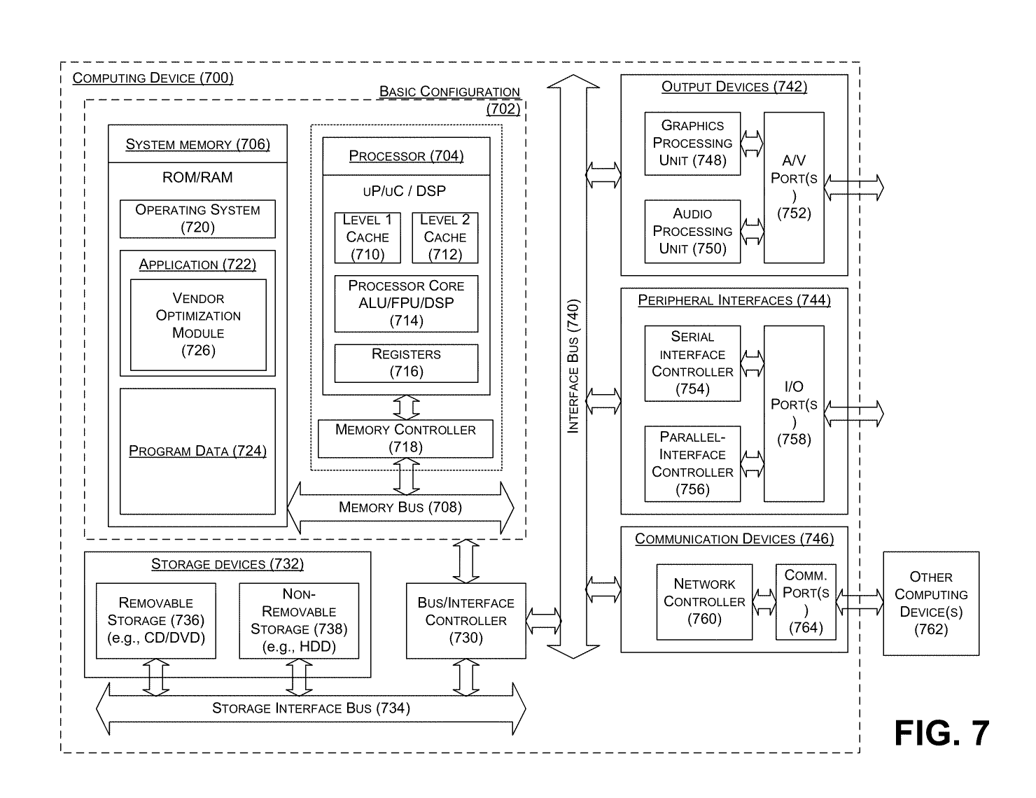

FIG. 7 is a block diagram illustrating an example computing device that is arranged for at least some of the embodiments of the subject disclosure. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include a wafer alignment module 726 that is arranged to perform the functions as described herein. Program data 724 may include wafer alignment process and resource information. In some embodiments, application 722 may be arranged to operate with program data 724 on operating system 720.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a controller in an industrial automation environment or as a personal computer including both laptop computer and non-laptop computer configurations.

Other than in the operating examples, or where otherwise indicated, all numbers, values and/or expressions referring to quantities of ingredients, reaction conditions, etc., used in the specification and claims are to be understood as modified in all instances by the term “about.”

With respect to any figure or numerical range for a given characteristic, a figure or a parameter from one range may be combined with another figure or a parameter from a different range for the same characteristic to generate a numerical range.

While certain embodiments have been described, these embodiments have been presented by way of example only, and are not intended to limit the scope of the inventions. Indeed, the methods and devices described herein can be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the subject innovation.

1. An overlay control system, comprising:
a wafer chuck that maneuvers a first wafer onto a wafer stage;
a scanning apparatus that performs wafer leveling using a pattern printed along a grid from a reticle that matches a set of alignment marks on a first wafer surface, wherein the scanning apparatus selects a set of the alignment marks that are not associated with wafer leveling hotspots and that are not associated with a reproducibility threshold which is lower than a reproducibility threshold of a second wafer, and wherein the second wafer is processed by a lithography tool before the first wafer is processed by the same lithography tool;
a processor that determines overlay correction parameters based on the set of the alignment marks; and
an alignment component that realigns the wafer using the overlay correction parameters.

2. The overlay control system of claim 1, wherein the wafer chuck is at least one of an electro-static chuck or a vacuum chuck.

3. The overlay control system of claim 1, wherein the wafer chuck maneuvers the first wafer onto the wafer stage based on a set of coordinates received from a database.

4. The overlay control system of claim 1, further comprising an update component that receives the overlay correction parameters and creates an updated set of coordinates.

5. The overlay control system of claim 4, wherein the update component sends the updated set of coordinates to the database.

6. (canceled)

7. The overlay control system of claim 1, wherein alignment marks not in the set of alignment marks are not selected to determine the overlay correction parameters.

8. The overlay control system of claim 5, wherein the wafer chuck repositions the first wafer based on the updated set of coordinates received from the database.

9. The overlay control system of claim 8, wherein in response to the wafer chuck repositioning the first wafer based on the updated set of coordinates, the scanning apparatus re-performs the wafer leveling.

10. A method, comprising:
maneuvering a first wafer onto a wafer stage;
overlaying a reticle over a surface of the first wafer; wherein the overlaying the reticle further comprises matching a set of alignment marks on a surface of the first wafer;
performing wafer leveling and selecting a set of alignment marks not associated with wafer leveling hotspots that exceed a threshold wafer leveling signature, wherein the set of alignment marks are not associated with a reproducibility threshold which is lower than a reproducibility threshold of a second wafer, and wherein the second wafer is processed by a lithography tool before the first wafer is processed by the same lithography tool ;
calculating overlay correction parameters based on the set of the alignment marks; and
realigning the first wafer using the overlay correction parameters.

11. The method of claim 10, wherein the maneuvering the first wafer onto the wafer stage is based on a set of coordinates received from a database.

12. The method of claim 11, further comprising creating an updated set of coordinates based on the overlay correction parameters and sending the updated set of coordinates to the database.

13. (canceled)

14. The method of claim 12, wherein the realigning the wafer further comprises repositioning the first wafer using the updated set of coordinates.

15. The method of claim 14, further comprising re-performing wafer leveling in response to repositioning the first wafer.

16. The method of claim 15, in response to the wafer leveling meeting a predefined specification, using the updated set of coordinates for batch processing.

17. The method of claim 15, in response to the wafer leveling not meeting a predefined specification, calculating new overlay correction parameters.

18. The method of claim 10, further comprising:
transferring a pattern on the reticle to an object wafer; and
processing the object wafer.

19. An overlay control system, comprising:
means for performing wafer leveling of a surface of a first wafer and selecting a set of alignment marks not associated with wafer leveling hotspots, wherein the set of alignment marks are not associated with a reproducibility threshold which is lower than a reproducibility threshold of a second wafer, and wherein the second wafer is processed by a lithography tool before the first wafer is processed by the same lithography tool;
means for calculating overlay correction parameters based on the set of alignment marks; and
means for realigning the first wafer using the overlay correction parameters.

20. The overlay control system of claim 19, further comprising:
means for creating an updated set of coordinates based on the overlay correction parameters; and
means for positioning a second third wafer using the updated set of coordinates.

21. The overlay control system of claim 19, further comprising:
means for re-performing waver leveling in response to realigning the first wafer;
means for calculating new overlay correction parameters in response to the wafer leveling not meeting a predefined specification.
